(19) United States
(12) Patent Application Publication
(10) Pub. No.: US 2025/0389369 A1
(43) Pub. Date: Dec. 25, 2025

(54) QUICK ASSEMBLY DEVICE

(71) Applicant: TILTA INC., Burbank, CA (US)

(72) Inventors: Weihan SHE, Shenzhen (CN); Wenping ZENG, Shenzhen (CN); Kefeng ZHOU, Shenzhen (CN)

(21) Appl. No.: 19/242,153

(22) Filed: Jun. 18, 2025

(30) Foreign Application Priority Data
Jun. 21, 2024 (CN) 2024214451528

(51) Int. Cl. F16M 11/04; G03B 17/56

(52) U.S. Cl. CPC F16M 11/041; G03B 17/561

(57) ABSTRACT

A quick assembly device includes: a mounting base on which a first clamping member and a second clamping member are oppositely arranged. The first clamping member and the second clamping member form a clamping groove for installing an equipment, with the second clamping member being movably mounted on the mounting base. A first triggering assembly is movably mounted on the mounting base, and a second triggering assembly is positioned at an end of the mounting base opposite to the second clamping member and is linked to the first triggering assembly. When the equipment being installed is loaded into the clamping groove, it can press the second clamping member to pivot. By locking the second triggering assembly, it can be made to abut against the first triggering assembly, so that the first triggering assembly abuts against the second clamping member, thereby locking the installed equipment in the clamping groove.

### CROSS-REFERENCE TO RELATED APPLICATIONS

The present application for patent claims priority to and the benefit of pending Chinese Application No. 202421445152.8, filed Jun. 21, 2024, and hereby expressly incorporated by reference herein as if fully set forth below in its entirety and for all applicable purposes.

### TECHNICAL FIELD

This disclosure pertains to the field of equipment assembly, specifically to a quick assembly device.

### INTRODUCTION

In related technologies, when using photographic equipment, a support is commonly used to hold it. The support is equipped with a quick-mount chute, and the corresponding photographic equipment is mounted on the support using a quick-mount plate. The sidewalls of the quick-mount chute are inclined, resulting in a trapezoidal cross-section. During assembly, the quick-mount plate must be aligned with the chute and then pushed in along the extension direction of the chute. Similarly, during disassembly, the quick-mount plate typically needs to be slid out along the extension direction of the chute. Both installation and disassembly processes are time-consuming.

### BRIEF SUMMARY

This disclosure provides a quick assembly device designed to address the time-consuming and inconvenient installation and disassembly processes associated with existing quick-mount chutes.

According to aspects of the disclosure, a quick assembly device including:
a mounting base, on which a first clamping member and a second clamping member are oppositely arranged; the first clamping member and the second clamping member form a clamping groove for installing an equipment in the clamping groove; the second clamping member is movably provided on the mounting base;
a first triggering assembly, which is movably provided on the mounting base and engages with the second clamping member;
a second triggering assembly, which is positioned at an end of the mounting base opposite to the second clamping member and engages with the first triggering assembly.

When the equipment to be installed is loaded into the clamping groove, it can press and pivot the second clamping member; by locking the second triggering assembly, it can be made to abut against the first triggering assembly, causing the first triggering assembly to abut against the second clamping member, thereby locking the equipment installed in the clamping groove; when the second triggering assembly is unlocked and the first triggering assembly is triggered, the second clamping member can reset, allowing the equipment to be released from the clamping groove.

### BRIEF DESCRIPTION OF THE DRAWINGS

FIG. 1 is a diagram illustrating an quick assembly device according to some aspects of the disclosure.

FIG. 2 is a diagram illustrating a top view of the quick assembly device according to some aspects of the disclosure.

FIG. 3 is a diagram illustrating a side view of the quick assembly device according to some aspects of the disclosure.

FIG. 4 is an exploded view of the quick assembly device according to some aspects of the disclosure.

FIG. 5 is a diagram illustrating the engagement between a clamping member and a first triggering assembly in a first state according to some aspects of the disclosure.

FIG. 6 is a diagram illustrating the engagement between the clamping member and the first triggering assembly of FIG. 5 in a second state according to some aspects of the disclosure.

FIG. 7 is a diagram illustrating the quick assembly device in a first state according to some aspects of the disclosure.

FIG. 8 is a diagram illustrating the first triggering assembly according to some aspects of the disclosure.

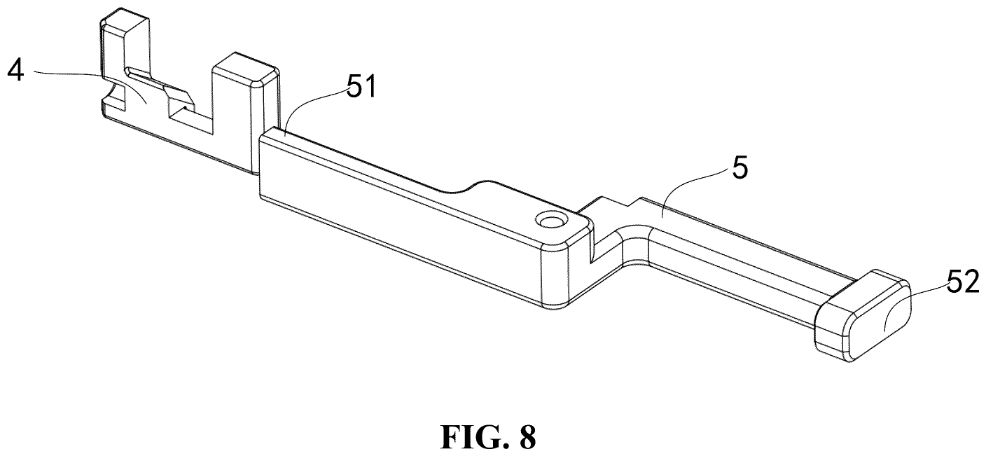

FIG. 9 is a diagram illustrating the locking state of a second triggering assembly according to some aspects of the disclosure.

FIG. 10 is a diagram illustrating the unlocking state of the second triggering assembly according to some aspects of the disclosure.

FIG. 11 is a diagram illustrating the second triggering assembly according to some aspects of the disclosure.

FIG. 12 is a partial cross-sectional view of a control member according to some aspects of the disclosure.

FIG. 13 is an exploded diagram of the quick assembly device according to some aspects of the disclosure.

FIG. 14 is another exploded diagram of the quick assembly device according to some aspects of the disclosure.

### DESCRIPTION OF REFERENCE NUMERALS

1—mounting base; 11—bearing groove; 12—first elastic connector; 13—limiting post;
2—first clamping member; 21—first limiting projection;
3—second clamping member; 30—first arm; 31—second limiting projection; 32—second arm; 33—locking projection;
4—first triggering assembly; 40—trigger; 41—abutting part; 42—limiting groove;
5—unlocking member; 51—driving part; 52—operating end;
6—second triggering assembly; 61—locking clamp; 62—connecting part; 63—pressing top; 64—control member; 641—adjusting screw; 65—pressing projection; 66—control switch; 67—hook; 68—torsion spring;
7—clamping groove;
8—quick-mount plate.

### DETAILED DESCRIPTION

Aspects of the present disclosure is further elaborated upon through detailed descriptions in conjunction with the drawings. Similar components across different aspects adopt associated and similar component labels. In the following embodiments, numerous detailed descriptions are provided to facilitate a better understanding of the present disclosure. However, those skilled in the art can readily recognize that some features can be omitted in various scenarios or replaced with other components, materials, or methods. In some instances, certain operations related to the present disclosure are not shown or described in the specification to avoid overwhelming the core aspects of the present application with excessive descriptions. For those skilled in the art, a detailed description of these related operations is unnecessary, as they can fully comprehend the related operations based on the specification's description and general technical knowledge in the field.

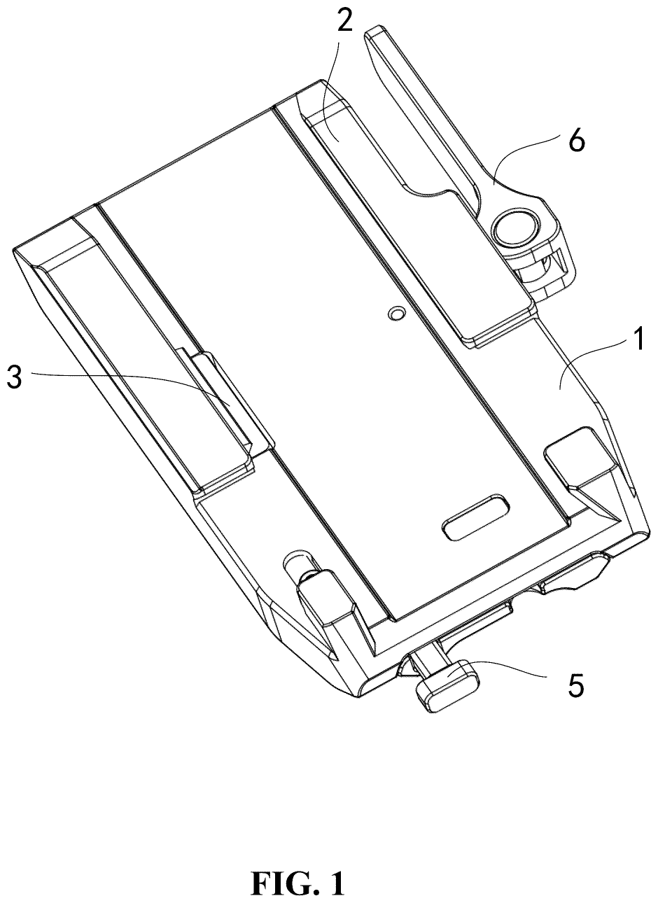

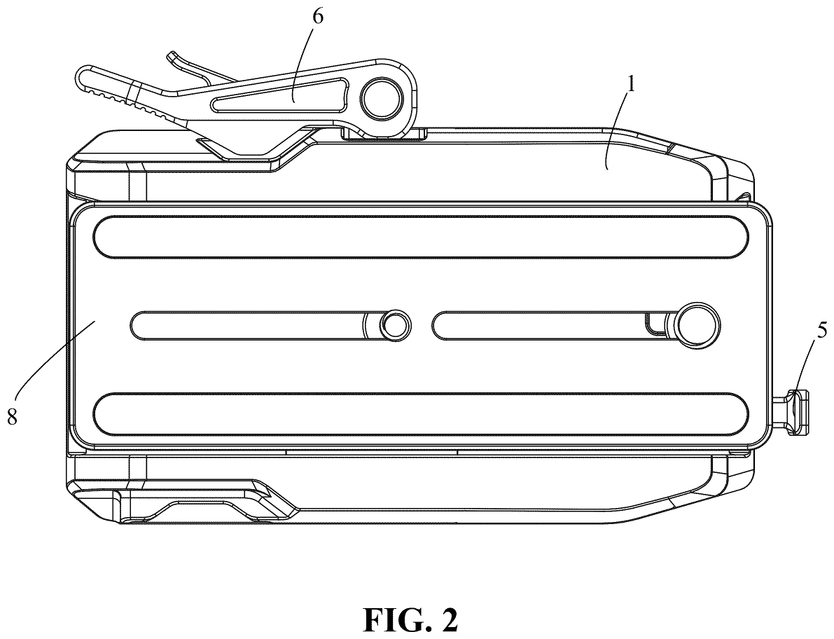

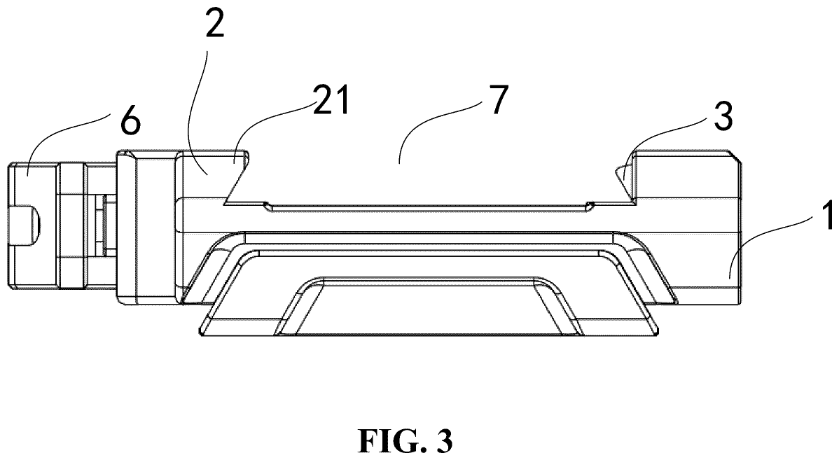

Referring to FIGS. 1-4, some aspects of the present disclosure present a quick assembly device for installing and disassembling an equipment. The quick assembly device includes:

A mounting base 1, a first clamping member 2, and a second clamping member 3 provided on the mounting base, used for installing an equipment, which are oppositely arranged. A clamping groove 7 is configured between the first clamping member 2 and the second clamping member 3 for accommodating the equipment (e.g., an external device) to be installed. The second clamping member 3 is movably provided on the mounting base 1, and the equipment is configured to drive the second clamping member 3 to pivot. The second clamping member 3 is pivotally connected to the mounting base 1.

A first triggering assembly 4, which is movably provided on the mounting base 1 and is interconnected with the second clamping member 3.

A second triggering assembly 6, which is positioned at the end of the mounting base 1 opposite to the second clamping member 3 and is interconnected with both the first triggering assembly 4 and the second clamping member 3. When the equipment being installed is loaded into the clamping groove 7, the equipment is configured to drive the second clamping member 3 to pivot relative to the mounting base 1. By locking the second triggering assembly 6, it can be made to engage with the first triggering assembly 4, causing the first triggering assembly 4 to engage with the second clamping member 3, thereby securing the equipment being installed within the clamping groove 7. When the second triggering assembly 6 is unlocked and the first triggering assembly 4 is activated, the second clamping member 3 can return to its original position (e.g., release position), enabling the equipment being installed to be released from the clamping groove 7.

As the main structure of the quick assembly device, the mounting base 1 serves to support the equipment to be installed, which is confined within the clamping groove 7 of the mounting base 1. The mounting base 1 can be a single-piece structure or assembled from multiple components, and it may include an internal cavity to house other parts and components of the quick assembly device. Due to the placement of the first clamping member 2 and the second clamping member 3 at respective opposite ends, in conjunction with the mounting base 1, the clamping groove 7 is formed. In other words, the clamping groove 7 is enclosed or defined by the surfaces of the first clamping member 2, the second clamping member 3, and the mounting base 1.

In some aspects, the quick assembly device of the present disclosure can adjust the space or distance between the first clamping member 2 and the second clamping member 3, i.e., the clamping groove 7, through the rotation of the second clamping member 3. When the equipment being installed on the bearing surface of the mounting base 1, driving and rotating the second clamping member 3 reduces the space between the first clamping member 2 and the second clamping member 3. Then, via the second triggering assembly 6, which engages with the first triggering assembly 4 to provide a locking force, the first triggering assembly 4 further engages with the second clamping member 3, causing the second clamping member 3 to firmly drive a quick-mount plate 8, thus locking the quick-mount plate 8 on which the equipment can be installed. In some examples, the quick-mount plate 8 can be a part or portion of the equipment. When the second triggering assembly 6 is rotated in the reverse direction and then the first triggering assembly 4 is activated, the second clamping member 3 returns to its original position (e.g., release position), expanding the space between the first clamping member 2 and the second clamping member 3, thereby releasing the quick-mount plate 8. In summary, the equipment is not restricted to being slid out from the front and rear ends of the first clamping member 2 and the second clamping member 3; it can also be removed from above or in an upward direction, reducing directional limitations and making disassembly and assembly more convenient and effortless.

It should be noted that the equipment can be or an assembly including the quick-mount plate 8, through which photographic equipment such as cameras or camera kits (e.g., cameras equipped with full cages, base plates, or half cages) can be installed. Taking a full cage as an example, the full cage is fitted over the camera and then installed on the quick-mount plate 8, which is provided in the space between the first clamping member 2 and the second clamping member 3.

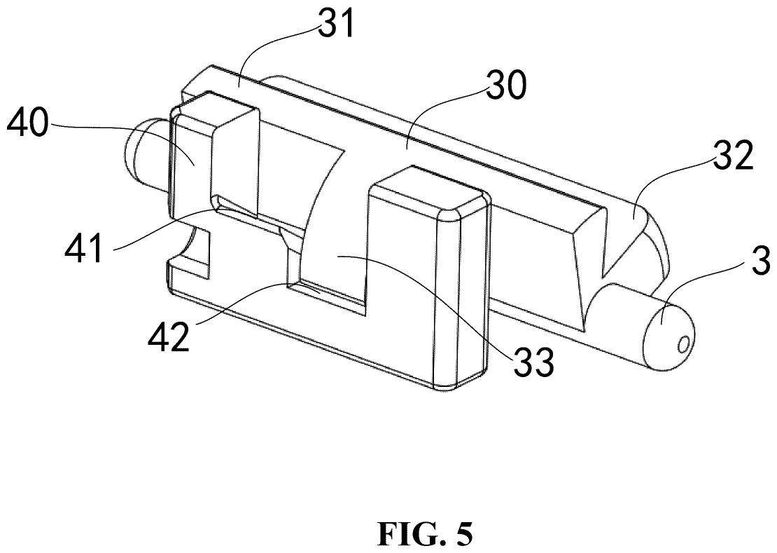

The first clamping member 2 and the second clamping member 3 are configured to clamp the equipment therebetween. To achieve clamping restriction of the equipment, the end of the first clamping member 2 that is away from the surface of the mounting base 1 is equipped with a first limiting projection 21, which extends towards the second clamping member 3. The second clamping member 3 is rotatably connected to the mounting base 1 via a rotating shaft. The end of the second clamping member 3 that is away from the mounting base 1 is provided with a second limiting projection 31 (see FIG. 5), which extends towards the first clamping member 2. In other words, the first clamping member 2 and the second clamping member 3 are respectively fitted with the first limiting projection 21 and the second limiting projection 31. The first limiting projection 21 and the second limiting projection 31 extend towards each other, creating a relatively smaller gap at the top of the first clamping member 2 and the second clamping member 3. A wider gap is formed between the bottom of the first clamping member 2 and the second clamping member 3.

To facilitate quick assembly and disassembly, in some aspects of this disclosure, a rotational connection is established between the second clamping member 3 and the mounting base 1. Based on this rotational connection, the second clamping member 3 can be rotated relative to the mounting base 1. Due to the rotational connection between the second clamping member 3 and the mounting base 1, the second clamping member 3 can adjust the relative position of its second limiting projection 31 with respect to the first clamping member 2 by rotating relative to the mounting base 1. Specifically, by rotating the second clamping member 3, the second limiting projection 31 can be moved away from the first clamping member 2, thereby expanding the space between the second limiting projection 31 and the first clamping member 2. This allows the equipment to be directly placed between the first clamping member 2 and the second clamping member 3 from above the mounting base 1, without sliding it in along the direction of the clamping groove 7, thus reducing installation time. On the other hand, by rotating the second clamping member 3, the second limiting projection 31 can be moved closer to the first clamping member 2, thereby reducing the space between the first limiting projection 21 and the second limiting projection 31. Meanwhile, the rotational state of the second clamping member 3 can be secured, preventing it from rotating in a direction that increases the gap between the first limiting projection 21 and the second limiting projection 31. This ensures that the equipment being installed, located between the first clamping member 2 and the second clamping member 3, cannot be removed in a direction perpendicular to the mounting base 1 or extension direction of clamping groove 7. When disassembly is required, the rotational lock of the second clamping member 3 can be released, and the installed equipment can be directly lifted out from the clamping groove 7. As the equipment is lifted, the second clamping member 3 will rotate accordingly, thereby releasing the equipment and enabling its removal.

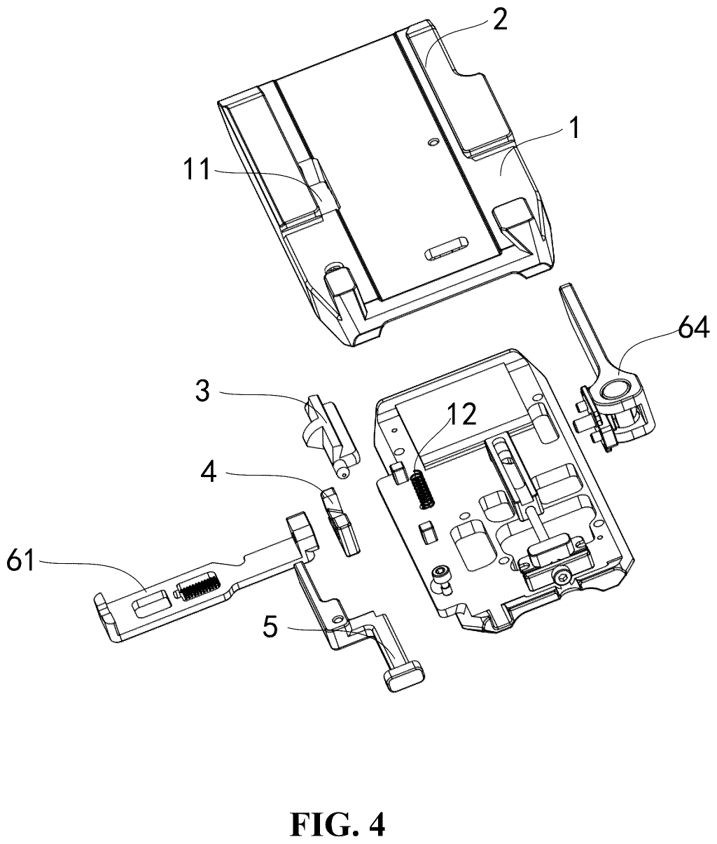

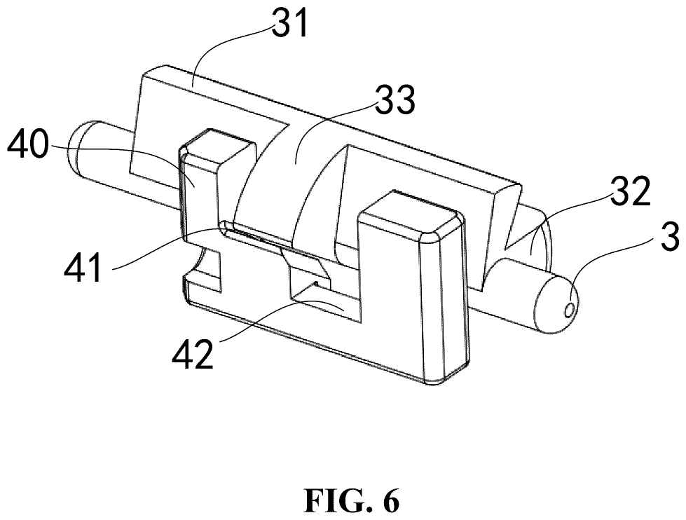

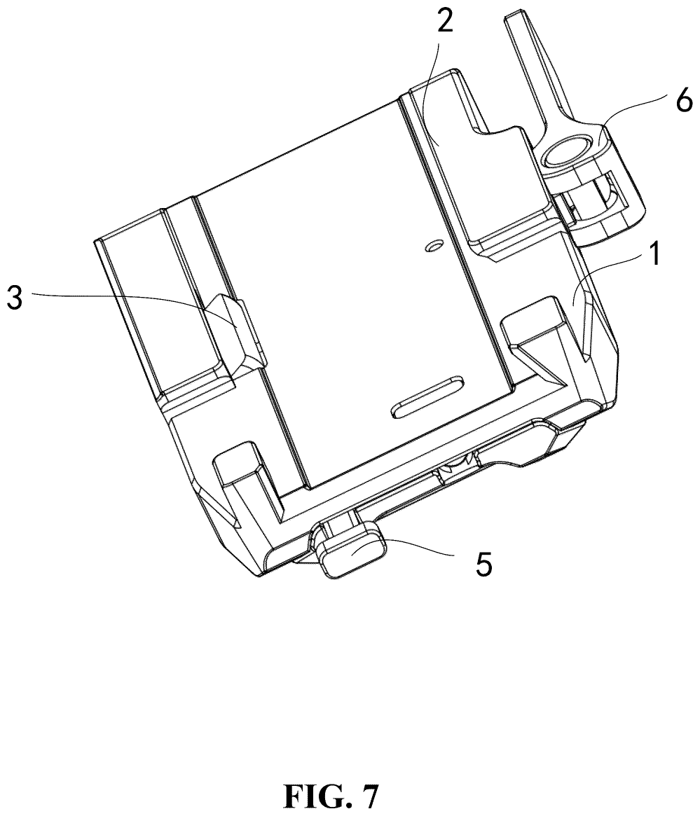

Referring to FIGS. 4-7, the quick assembly device in some aspects of this disclosure includes a first triggering assembly 4, which is movably provided on the mounting base 1 and is capable of driving the second clamping member 3 to return to its original position. There are at least two states between the second clamping member 3 and the mounting base 1. In the first state (release state), the space between the second limiting projection 31 and the first clamping member 2 is increased to allow the equipment to be placed between the first clamping member 2 and the second clamping member 3. In the second state (installed state), the space between the second limiting projection 31 and the first limiting projection 21 is reduced to further prevent the installed equipment from being removed. Since the first triggering assembly 4 is movably connected to the mounting base 1, the first triggering assembly 4 can adjust its connection with the second clamping member 3 by changing positions, thus enabling the second clamping member 3 to switch between different rotational states (e.g., angles). Among the various rotational states of the second clamping member 3, there are at least two states. The first one is an open state, which is applicable before installing the equipment being installed. In this state, the maximum spacing between the second limiting projection 31 and the first clamping member 2 is greater than the dimensions of the equipment being installed. The second state is an installation state, which is applicable for locking the installed equipment. In this state, the space between the first limiting projection 21 and the second limiting projection 31 is reduced to restrict the movement of the installed equipment.

In some aspects, to control rotational positioning of the second clamping member 3, the first triggering assembly 4 includes a trigger 40 equipped with an abutting part 41 and a limiting groove 42. The abutting part 41 is positioned at a higher elevation than the limiting groove 42. The second clamping member 3 features a locking projection 33. The trigger 40 is capable of reciprocating motion relative to the mounting base 1, enabling the locking projection 33 to alternate between abutting against the abutting part 41 and accommodation within the limiting groove 42. The abutting part 41 and the limiting groove 42 interact with the locking projection 33 on the second clamping member 3 to achieve rotational locking of the second clamping member 3 in the second state (installed state) and the first state (release state), respectively. Specifically, the trigger 40 can reciprocate relative to the mounting base 1. Consequently, the trigger 40 can be moved to alternate between the abutting part 41 and the limiting groove 42, bringing each into contact with the locking projection 33. When the locking projection 33 is in contact with the lower limiting groove 42, the second limiting projection 31 moves away from the first clamping member 2, and the second clamping member 3 transitions into the first state (release state). When the locking projection 33 is in contact with the abutting part 41, which is positioned higher than the limiting groove 42, the second clamping member 3 rotates accordingly, causing the second limiting projection 31 to move closer to the first limiting projection 21, and the second clamping member 3 enters the second state (installed state).

To facilitate the transition of the locking projection 33 between the abutting part 41 and the limiting groove 42, the end-surfaces where the abutting part 41 and the locking projection 33 come into contact may be inclined. Additionally, a beveled or rounded surface may be provided at the transition between the abutting part 41 and the limiting groove 42 to facilitate the smooth sliding of the locking projection 33 between the abutting part 41 and the limiting groove 42.

In some aspects, to rapidly reset the rotational locking of the second clamping member 3 by the first triggering assembly 4, the trigger 40 can be connected to the mounting base 1 via a second elastic connector. Since the first triggering assembly 4 is connected to the mounting base 1 through the second elastic connector, the first triggering assembly 4 tends to return to its original position after sliding relative to the mounting base 1. When the trigger 40 moves to bring the locking projection 33 into contact with the limiting groove 42, the elastic potential energy of the second elastic connector increases. Subsequently, when the second clamping member 3 rotates, causing the locking projection 33 to disengage from the limiting groove 42, the trigger 40 moves in the direction of the second elastic connector's deformation recovery, bringing the abutting part 41 into contact with the locking projection 33.

In some aspects, to facilitate the switching of the rotational locking state of the second clamping member 3 by the first triggering assembly 4, the first triggering assembly 4 may include an unlocking member 5, which is movably connected to the mounting base 1 and at least partially exposed outside the mounting base 1. The unlocking member 5 is used to control the reciprocating movement of the trigger 40 relative to the mounting base 1. The unlocking member 5 may be fixedly connected to the abutting part 41 and the limiting groove 42. Therefore, as the unlocking member 5 moves, the positions of the abutting part 41 and the limiting groove 42 can be adjusted, thereby switching the rotational locking of the second clamping member 3. Alternatively, the unlocking member 5 may only be in contact with the abutting part 41 and the limiting groove 42, meaning the unlocking member 5 can switch the positions of the abutting part 41 and the limiting groove 42 by pushing. After pushing, the abutting part 41 and the limiting groove 42 can return to their original positions under the action of the elastic potential energy of the second elastic connector.

Specifically, the unlocking member 5 may include a driving part 51 and an operating end 52 (e.g., a cap) that is exposed outside the mounting base 1. The driving part 51 is used to control the movement position of the abutting part 41 and the limiting groove 42 relative to the mounting base 1 under the drive of the operating end 52.

In some aspects, to enhance installation convenience, the second clamping member 3 includes a first arm 30 and a second arm 32. A pressing position for pressing by the equipment is formed between the first arm 30 and the second arm 32. The locking projection 33 is located on the side of the first arm 30 facing away from the second arm 32. The first triggering assembly 4 is movably provided within the internal chamber of the mounting base 1 and is located on the same side of the first arm 30 as the locking projection 33. The first arm 30 and the second arm 32 may be integrally formed, with the second limiting projection 31 formed by the first arm 30. The second arm 32 can serve two functions: one is to cooperate with the second limiting projection 31 to form part of the clamping groove 7 for accommodating the installed equipment; the other is to act as a triggering component for the equipment. When the second clamping member 3 is in the first state, the equipment to be installed is pressed down. During the pressing process, the equipment comes into contact with the second arm 32 and drives it to move downward. The movement of the second arm 32 causes the second clamping member 3 to rotate, gradually transitioning it to the second state. In this state, the second arm 32 rotates into a bearing groove 11 provided on the surface of the mounting base 1, avoiding restrictions on the posture of the installed equipment.

It is worth noting that even if the second arm 32 is not provided, the second limiting projection 31 can still cooperate with the surface of the mounting base 1 to form part of the clamping groove 7.

In some aspects, to enable the second clamping member 3 to automatically return to its original rotational state, the second arm 32 is elastically connected to the mounting base 1 via the first elastic connector 12 (e.g., a spring) at the bearing groove 11. The elastic potential energy (e.g., stored spring energy) of the first elastic connector 12 in the second state exceeds that in the first state. Due to the greater elastic potential energy of the first elastic connector 12 in the second state (installed state), when the second clamping member 3 is in the second state (installed state), the first elastic connector 12 causes the second clamping member 3 to gain a tendency to rotate back to the first state (release state). Once the rotational locking of the second clamping member 3 is released, the second clamping member 3 will rotate to the first state (release state), preparing for the next installation of the equipment.

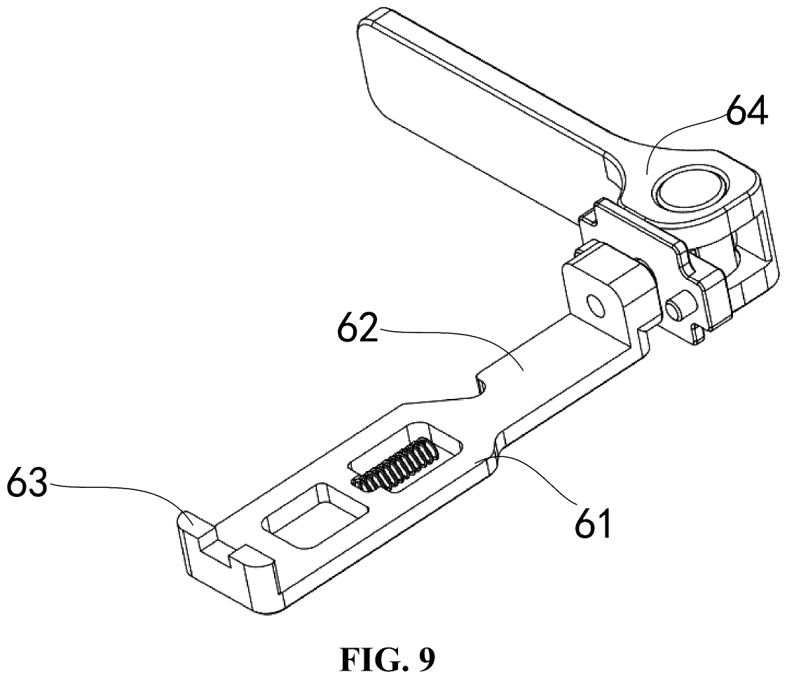

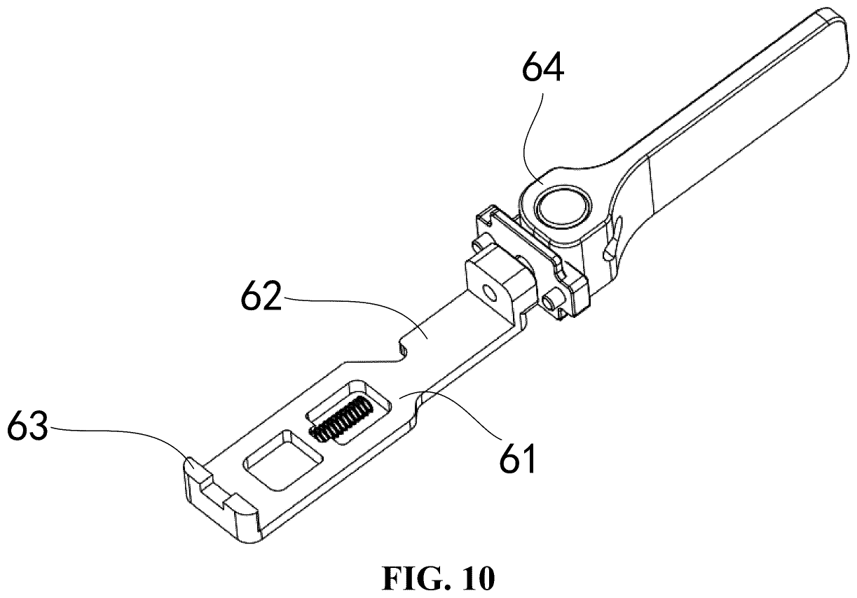

In some aspects, to directly and fully lock the current state of the quick assembly device, with reference to FIGS. 9 and 10, the quick assembly device may further include a second triggering assembly 6. The second triggering assembly 6 includes a locking clamp 61 and a control member 64. The locking clamp 61 is provided within the internal chamber of the mounting base 1 and is interconnected with the first triggering assembly 4. The control member 64 is movably connected to the locking clamp 61 and is located at the end of the mounting base 1 opposite the second clamping member 3. When the equipment is installed into the clamping groove 7, it can drive the second clamping member 3 to flip. By locking the control member 64, the locking clamp 61 can be moved to abut against the first triggering assembly 4, causing the first triggering assembly 4 to abut against the second clamping member 3, driving the second clamping member 3 against the quick-mount plate 8, thereby locking the equipment installed in the clamping groove 7. When the control member 64 is unlocked and the first triggering assembly 4 is activated, the second clamping member 3 can reset, increasing the space between the first clamping member 2 and the second clamping member 3, allowing the installed equipment to be released from the clamping groove 7.

In some aspects, the locking clamp 61 may include a connecting part 62 and a pressing top 63. The connecting part 62 extends along the direction connecting the first clamping member 2 and the second clamping member 3. The pressing top 63 is disposed at the end of the connecting part 62 opposite the control member 64 and is located on the side of the first triggering assembly 4 facing away from the second clamping member 3. The control member 64 is used to control the locking clamp 61 to switch the pressing top 63 between abutting and non-abutting states with the first triggering assembly 4. The second triggering assembly 6 is configured to lock the position of the first triggering assembly 4, preventing it from moving before the second triggering assembly 6 is unlocked, thereby further locking the rotational state of the second clamping member 3. It can also release the locked state of the first triggering assembly 4, triggering the first triggering assembly 4 to reset the second clamping member 3. The locking clamp 61 includes the connecting part 62 and the pressing top 63. The connecting part 62 is used to connect the pressing top 63 with the control member 64. The pressing top 63 is provided opposite the first triggering assembly 4. Under the control of the control member 64, the gap between the pressing top 63 and the first triggering assembly 4 can be adjusted, enabling the pressing top 63 to switch between abutting and non-abutting states with the first triggering assembly 4. In the abutting state, the pressing top 63 is in close contact with the first triggering assembly 4, restricting its movement. In the non-abutting state, the pressing top 63 does not restrict the position of the first triggering assembly 4, allowing it to be triggered to reset the second clamping member 3.

In some aspects, to facilitate the locking operation, the connecting part 62 is elastically connected to the mounting base 1, creating a containment space between the connecting part 62 and the pressing top 63. Both the second clamping member 3 and the first triggering assembly 4 are positioned within this containment space. Given their placement within the containment space formed between the connecting part 62 and the pressing top 63, when the locking clamp 61 is locked under the action of the control member 64, the pressing top 63 moves toward the control member 64, reducing the size (e.g., a width) of the containment space. This causes the pressing top 63 to abut against and constrain both the first triggering assembly 4 and the second clamping member 3.

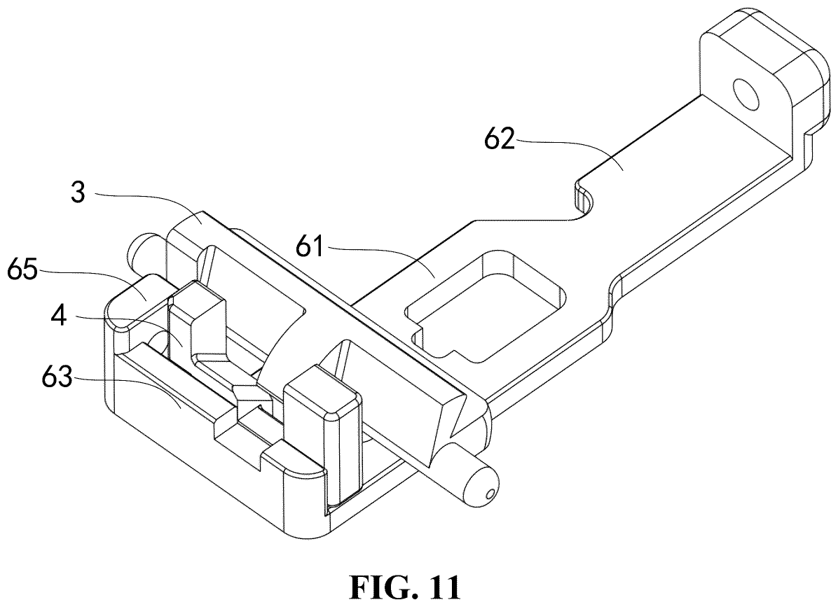

In some aspects, referring to FIG. 11, to further enhance locking reliability, a pressing projection 65 is provided at the end of the pressing top 63 facing the second clamping member 3. The function of the pressing projection 65 is that, when the locking clamp 61 is locked, the pressing projection 65 can bypass the first triggering assembly 4 and directly contact the second clamping member 3. This allows the locking clamp 61 to directly lock the second clamping member 3 without requiring the first triggering assembly 4 to fully lock the second clamping member 3. In other words, in some aspects of this disclosure, in addition to being interconnected with the first triggering assembly 4, the locking clamp can also be directly interconnected with the second clamping member 3 through the pressing projection 65, thereby enhancing locking reliability.

In some aspects, to facilitate the adjustment of locking and unlocking, the control member 64 can be a locking wrench rotatably connected to the mounting base 1. The locking wrench controls the relative position between the locking clamp 61 and the mounting base 1 through rotation. The locking wrench can abut against the mounting base 1 with a head of varying outer diameter. When the outer diameter at the abutment between the locking wrench and the mounting base 1 increases, the pressing top 63 is pulled taut by the connecting part 62, coming into close contact with the first triggering assembly 4 for locking. Conversely, when the outer diameter at the abutment decreases, the pressing top 63 relaxes, unlocking the first triggering assembly 4.

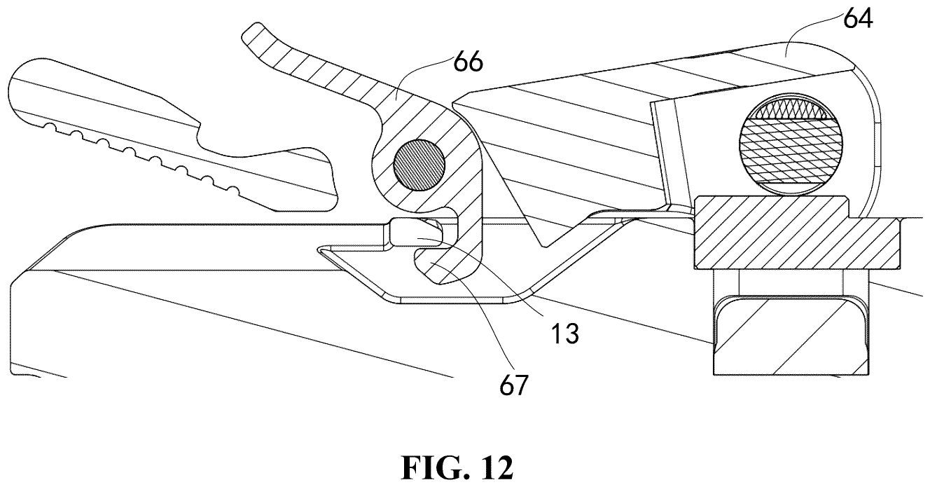

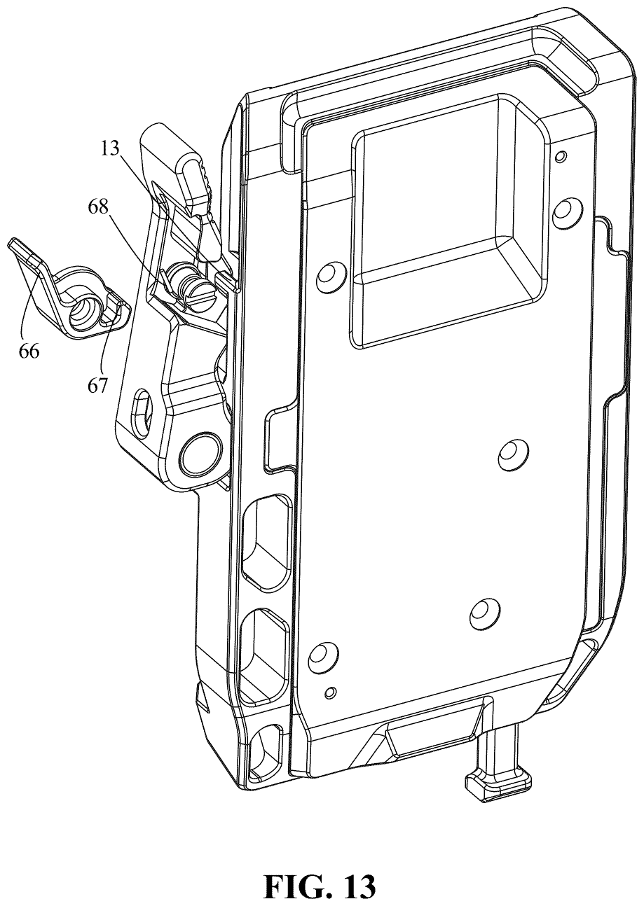

In some aspects, referring to FIGS. 12-13, to prevent accidental triggering of the control member 64, a control switch 66 can be elastically provided on the control member 64. A limiting post 13 that cooperates with the control switch 66 is provided on the mounting base 1. The control switch 66 can engage with the limiting post 13 to restrict the movement of the control member 64. By incorporating the control switch 66, the mobility of the control member 64 can be restricted, thereby avoiding accidental triggering and operation that could lead to the accidental unlocking of the installed equipment. Specifically, the control switch 66 can be rotationally connected to the control member 64. A hook 67 is provided on the control switch 66. Through relative rotation between the control switch 66 and the control member 64, the hook 67 can engage with or disengage from the limiting post 13. The hook 67 can engage with the limiting post 13. By adjusting the rotational relationship between the control switch 66 and the control member 64, the relative position between the control switch 66 and the limiting post 13 can be switched, thereby locking or unlocking the control member 64. It is worth noting that the control switch 66 can be elastically connected to the control member 64 via a torsion spring 68. For example, when the control member 64 is pried open or released, the control switch 66 is simultaneously pressed down, causing the hook 67 of the control switch 66 to disengage from the limiting post 13, unlocking the control member 64 and allowing it to be pried. When the control member 64 is tightened, since the control switch 66 is elastically connected to the control member 64, the limiting post 13 can push the hook 67 aside, and then the torsion spring 68 drives the hook 67 to reset, locking the control member 64 again. Therefore, when the control member 64 is tightened, the user does not need to simultaneously operate the control switch 66, although it is also possible to do so.

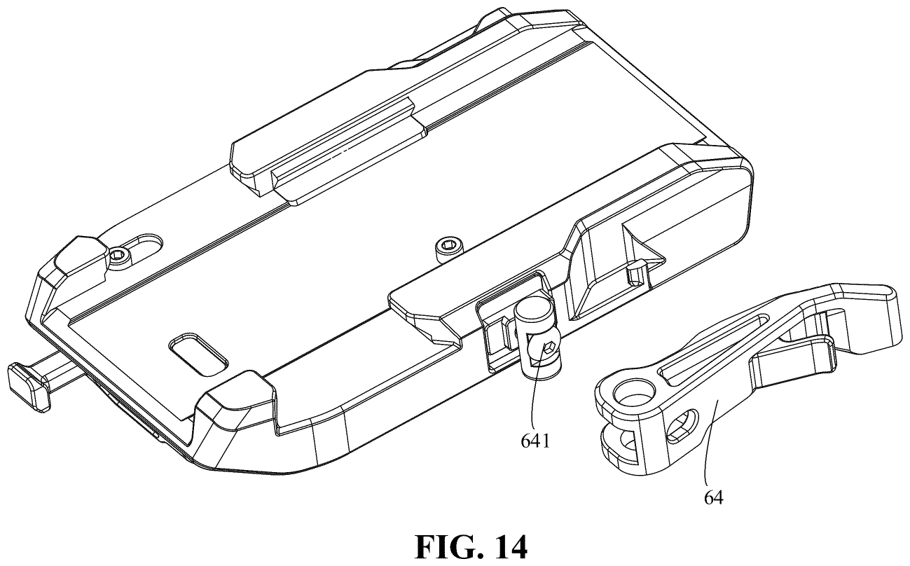

Referring to FIG. 14, in some aspects, the control member 64 can be connected to the connecting part 62 through an adjusting screw 641. Auxiliary tools (such as a wrench) can be used to rotate the adjusting screw 641 to adjust the locking force of the control member 64, among other parameters.

In some aspects, the first clamping member 2 can be integrally formed with the mounting base 1 to ensure the strength of the product. Alternatively, the first clamping member 2 can also be rotatably connected to the mounting base 1. When the first clamping member 2 is rotatably connected to the mounting base 1, it can achieve rotational locking through a structure that matches the second clamping member 3, though this will not be elaborated upon here.

The aspects of this disclosure provide a quick-assembly device. Since the second clamping member 3 is movably disposed on the mounting base 1 and the equipment to be installed can drive the second clamping member 3 to flip, during installation, the equipment to be installed can be directly pressed down against the second clamping member 3, driving it to flip and achieve locking installation. During disassembly, the installed equipment can be directly pulled out from the top of the mounting base 1 without the need to slide (e.g., push or pull) it in the direction of the clamping groove 7, significantly reducing the time required for installation and disassembly and improving operational convenience.

The above description uses specific examples to elaborate on the present disclosure, which is solely for the purpose of aiding understanding and is not intended to limit the present disclosure. For those skilled in the technical field to which the present disclosure belongs, based on the idea of the present disclosure, several simple deductions, deformations, or substitutions can also be made.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable.

What is claimed is:

1. A quick assembly device, comprising:
a mounting base comprising a first clamping member and a second clamping member that are opposite to each other;
wherein a clamping groove is configured between the first clamping member and the second clamping member for installing an equipment, and the second clamping member being movably provided on the mounting base;
a first triggering assembly that is movably provided on the mounting base and cooperates with the second clamping member;
a second triggering assembly that is provided at an end of the mounting base opposite to the second clamping member and cooperates with the first triggering assembly to install the equipment into the clamping groove;
the second clamping member is configured to pivot driven by the equipment in response to the equipment being installed into the clamping groove;
wherein, in response to the second triggering assembly being locked, the second triggering assembly is configured to abut against the first triggering assembly, causing the first triggering assembly to abut against the second clamping member, thereby locking the equipment installed in the clamping groove; and
wherein, in response to the second triggering assembly being unlocked and the first triggering assembly being triggered, the second clamping member is configured to reset, enabling the equipment to be released from the clamping groove.

2. The quick assembly device as claimed in claim 1, wherein the first triggering assembly comprises a trigger with an abutting part and a limiting groove, the abutting part being positioned higher than the limiting groove; and
wherein the second clamping member is provided with a locking projection, and the trigger is configured to reciprocate relative to the mounting base, enabling the locking projection to switch between abutting against the abutting part and being accommodated in the limiting groove.

3. The quick assembly device as claimed in claim 2, wherein the first triggering assembly further comprises an unlocking member; wherein the unlocking member is movably connected to the mounting base and is at least partially exposed outside the mounting base; and
wherein the unlocking member is configured to control the trigger to reciprocate relative to the mounting base.

4. The quick assembly device as claimed in claim 2, wherein the second clamping member is pivotally connected to the mounting base;
wherein the second clamping member comprises a first arm and a second arm, that provide a pressing position for the equipment to be installed being formed between the first arm and the second arm; and
wherein the locking projection is provided on a side of the first arm facing away from the second arm, and the trigger is movably provided on the mounting base and is located on a side of the first arm, alongside the locking projection.

5. The quick assembly device as claimed in any one of claim 1, wherein the second triggering assembly comprises a locking clamp and a control member;
wherein the locking clamp is provided in an internal cavity of the mounting base and cooperates with the first triggering assembly;
wherein the control member is movably connected to the locking clamp and is located at an end of the mounting base opposite to the second clamping member;
wherein in response to the equipment being installed into the clamping groove, the second clamping member is configured to pivot;
wherein in response to the control member being locked, the locking clamp is configured to move to abut against the first triggering assembly, causing the first triggering assembly to abut against the second clamping member, thereby locking the equipment in the clamping groove; and
wherein in response to the control member being unlocked and the first triggering assembly being triggered, the second clamping member is configured to reset, enabling the equipment to be released from the clamping groove.

6. The quick assembly device as claimed in claim 5, wherein the locking clamp comprises a connecting part and a pressing top;
wherein the connecting part extends along a direction connecting the first clamping member and the second clamping member;
wherein the pressing top is provided at an end of the connecting part away from the control member and is located on a side of the first triggering assembly facing away from the second clamping member; and
wherein the control member is configured to control the locking clamp to switch the pressing top between abutting against and not abutting against the first triggering assembly.

7. The quick assembly device as claimed in claim 6, wherein the connecting part is elastically connected to the mounting base, and an accommodation space is formed between the connecting part and the pressing top; and
wherein both the second clamping member and the first triggering assembly are provided in the accommodation space.

8. The quick assembly device as claimed in claim 6, wherein a pressing projection is provided at an end of the pressing top facing the second clamping member.

9. The quick assembly device as claimed in claim 5, further comprising a control switch elastically provided on the control member, and a limiting post cooperating with the control switch provided on the mounting base; wherein the control switch is engageable with the limiting post to restrict a movement of the control member.

10. The quick assembly device as claimed in claim 9, wherein the control switch is pivotally connected to the control member; and
wherein a hook is provided on the control switch, and by relative rotation between the control switch and the control member, the hook is configured to switch between engaging with or disengaging from the limiting post.
